(19) United States
(12) Patent Application Publication
(10) Pub. No.: US 2013/0338820 A1
(43) Pub. Date: Dec. 19, 2013

(54) Automated Electric Vehicle Charging Station

(71) Applicants: Adrian Corbett, Mission Viejo, CA (US); Robert Maniaci, Villa Park, CA (US)

(72) Inventors: Adrian Corbett, Mission Viejo, CA (US); Robert Maniaci, Villa Park, CA (US)

(21) Appl. No.: 13/904,811

(22) Filed: May 29, 2013

Related U.S. Application Data
(60) Provisional application No. 61/653,399, filed on May 30, 2012.

(51) Int. Cl. B60L 11/18

(52) U.S. Cl. CPC B60L 11/1824
USPC 700/232; 320/109

(57) ABSTRACT

An Automated Electric Vehicle Charging Station is disclosed. The Charging Station should can automatically connect to an electrically-powered vehicle and commence the recharging process. The charging process involves the charging station discovering and locating the vehicle's charging port. Once discovered and located, the charging station can reach out and make the electrical interconnection with the vehicle while the vehicle is located at an adjacent parking space. The charging station is retrofittable into an existing parking lot, in addition to its being a part of the original lot construction. A companion software application on a computing device such as a mobile phone may be used to activate and monitor the charging process, amd locating charging stations and providing customer billing status. Docking between the charging station robotic arm and the vehicle can be facilitated by a variety of locating/handshaking methods, including wireless signalling, video camera and infrared triangulation, for example.

This application is filed within one year of, and claims priority to Provisional Application Ser. No. 61/653,399, filed May 30, 2012.

### BACKGROUND OF THE INVENTION

1. Field of the Invention

This invention relates generally to electric vehicles and related equipment and, more specifically, to an Automated Electric Vehicle Charging Station.

2. Description of Related Art

With the emergence of a new era for electric vehicles, there are two major popular concerns related to EV ownership. The first issue is commonly known as “range anxiety,” or a fear that the electric vehicle will not be a suitable mode of transportation for certain regular routes because of its limited range. The second concern is the inconvenience of manually connecting and disconnecting the standard unwieldy power cord and plug from the vehicle several times per week.

It is possible for a single device to be the solution to both problems. The device would offer public EV charging stations in numerous locations, and would eliminate the need to manually plug and unplug the EV from the charging station. The inventor of this new device is unaware of any such similar offering in any of the prior art.

### SUMMARY OF THE INVENTION

In light of the aforementioned problems associated with the prior devices and systems, it is an object of the present invention to provide an Automated Electric Vehicle Charging Station. The Charging Station should be able to automatically connect to an electrically-powered vehicle and commence the recharging process. A part of the charging process should involve the charging station discovering and locating the vehicle's charging port. Once discovered and located, the charging station should be capable to reaching out and making the electrical interconnection with the vehicle while the vehicle is located at an adjacent parking space. The charging station should be retrofittable into an existing parking lot, in addition to being a part of the original lot construction. A companion software application on a computing device, such as a mobile phone, could activate and monitor the charging process, as well as locating charging stations and providing customer billing status. Docking between the charging station robotic arm and the vehicle should be facilitated by a variety of locating/handshaking methods, including wireless signalling, video camera and infrared triangulation, for example.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, of which:

FIG. 1 is a perspective view of a preferred embodiment of the vehicle charging assembly of the present invention;

FIG. 2 is a perspective view of the interconnect element of the assembly of FIG. 1;

FIG. 3 is a front view of a preferred embodiment of a modified license plate holder configured to cooperate with the element of FIG. 1;

FIG. 4 is a perspective view of the element of FIG. 2 engaging the holder of FIG. 3;

FIG. 5 is a top view of a preferred control interface device for interacting with the assembly of FIG. 1;

FIG. 6 is a flowchart depicting the preferred steps of the charging method of present invention;

FIG. 7 is a perspective view of a retrofit version of the assembly of FIG. 1;

FIG. 8 is a side view of an EV engaged with the assembly of FIGS. 1 and 7 during a charging session;

FIG. 9 is a perspective view of a conventional parking lot having a plurality of new construction assemblies of the present invention installed therein;

FIG. 10 is a perspective view of the assembly of FIG. 7, depicting the use of the backup conventional charging cable;

FIG. 11 depicts radio frequency positioning; and

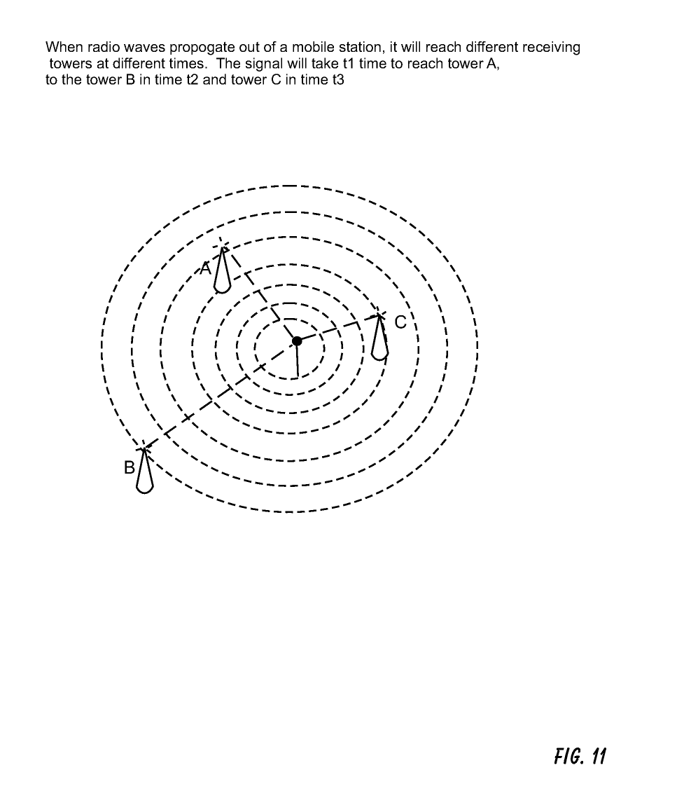

FIG. 12 depicts infrared positioning.

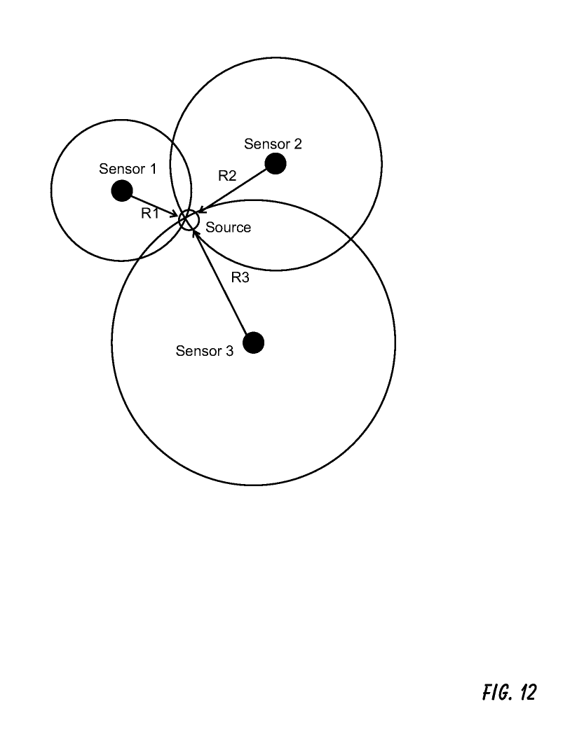

Further illustrations and operation of the present invention can be accessed at www.autocharge.com, the content thereof is incorporated herein as set forth in haec verba as of the date of this application as presently filed.

### DETAILED DESCRIPTION OF THE PREFERRED EMBODIMENTS

The following description is provided to enable any person skilled in the art to make and use the invention and sets forth the best modes contemplated by the inventors of carrying out their invention. Various modifications, however, will remain readily apparent to those skilled in the art, since the generic principles of the present invention have been defined herein specifically to provide an Automated Electric Vehicle Charging Station.

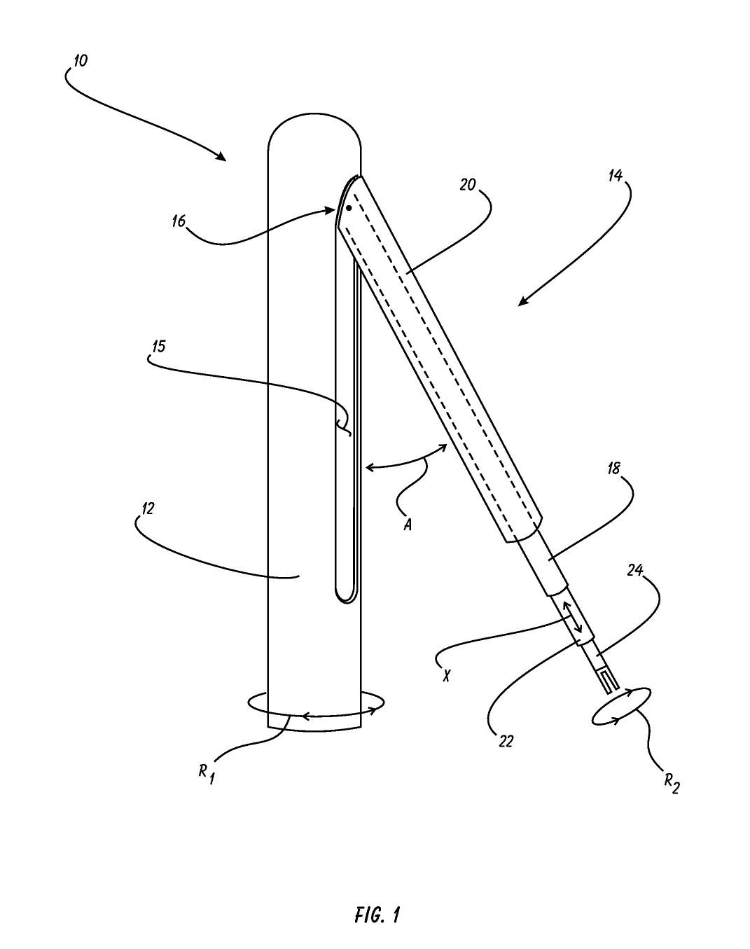

The present invention can best be understood by initial consideration of FIG. 1. FIG. 1 is a perspective view of a preferred embodiment of the vehicle charging assembly 10 of the present invention. The assembly 10 comprises a central, upstanding, pivoting post 12, from which a robotic arm 14 is extendable. The post 12 can rotate back and forth in direction R1 in order to facilitate engagement between the arm 14 and the Electric Vehicle (EV).

When not in use, the robotic arm 14 is housed within arm cavity 15 formed within the post 12. The arm 14 can swing out and back (see direction A) from the cavity 15 around hinge 16 located near the top of the post 12 and arm 14. There is an arm cover 20 attached to the outwardly-facing side of the arm 14 that provides improved asethetics for the arm 14, and conforms to the outer profile of the post 12 when the arm 14 is in the stowed position within the arm cavity 15.

The arm cover 20 is attached to the main structural element of the arm 14, namely the proximal arm segment 18. The proximal arm segment 18 is pivotally attached to the post 12 at hinge 16, and is the portion of the arm 14 that is driven away and towards the cavity 15 by an internal motorized mechanism within the post 12. One or more distal arm segments 22 are housed within the proximal arm segment 18. The proximal arm segment(s) 18 are driven in direction X to extend and retract from the end of the proximal arm segment 18 (in a telescopic fashion) so that the assembly 10 can reach out to a parked vehicle to commence the charging process.

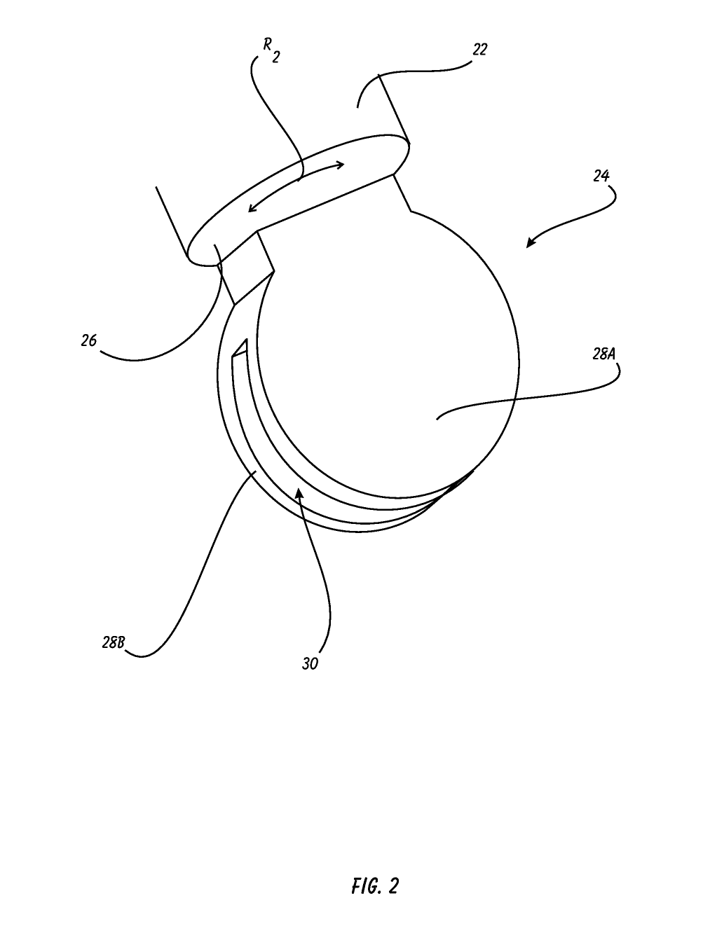

The arm 14 terminates in an interconnect element 24 extending from the last distal arm segment 22. The interconnect element 24 provides the actual electrical connection point for the EVs undergoing the charging process. There is a pivotal connection between the interconnect element 24 and the final distal arm segment 22 to allow the element 24 to rotate in direction R2, so that it can adjust to the positioning of the parked vehicle. This element 24 is more fully discussed below in connection with FIG. 2.

FIG. 2 is a perspective view of the interconnect element 24 of the assembly of FIG. 1. As discussed previously, the interconnect element 24 rotatably attaches to the distal arm segment 22 at rotating base 26, which is driven to rotate back and forth in direction R2. The actual electrical connection between the charging assembly and the EV is accomplished by the paddle assembly extending outwardly from the base 26. The paddle assembly comprises of first paddle section 28A and second paddle section 28B in parallel spaced relation to each other, and having a center slot 30 formed between them.

The paddle sections 28A and 28B are formed from a durable, non-conductive material. The facing surfaces of the paddle sections 28A, 28B each define separate metallic contact plates (not shown) for providing the actual electrical connection between the charging assembly and the EV. Placement of the contact plates in between the paddle sections 28A, 28B serves to prevent inadvertent contact between live electrical components and external structures (or individuals). As should be apparent from the paddle design, it is a simple matter of sliding a cooperating contact blade (having external contact plates) into the center slot 30 of the interconnect element 24 so that the metallic contacts of the interconnect element 24 come into contact with the corresponding external contact plates dispersed on the outer surface of the contact blade. We will now turn to the contact assembly on the electric vehicle itself.

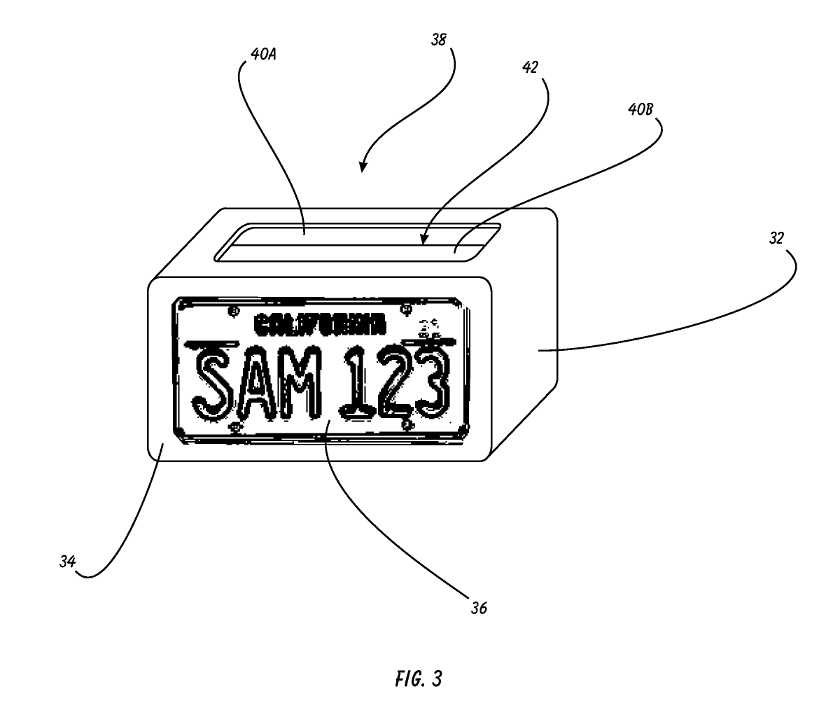

FIG. 3 is a front view of a preferred embodiment of a modified license plate holder 32 configured to cooperate with the element of FIG. 1. The license plate holder 32 depicted here is intended to be installed on a vehicle to make the vehicle compatible with the charging station of the present invention. While the holder 32 could also be incorporated within a vehicle as original equipment, such a design may look somewhat different from the holder 32 described herein. For example, the housing 34 could be mounted in the central grill or central upper front bumper area, as desired by the Original Equipment Manufacturer (or after-market manufacturer).

The holder 32 replaces the original equipment license plate holder that came with the vehicle. The housing 34 is typically made from a form of plastic that is preferably color-matched (or contrasted with) the vehicle's body color. Other materials could be used, depending upon the particular aesthetic and functional features desired. The front-facing wall of the housing 34 is configured to hold the vehicle's license plate 36. A receiver 38 is formed in the top wall of the housing 34. The receiver 38 is, essentially a contact “blade” secured within the housing 34 and reachable through a pair of spring-loaded doors on the upper surface of the housing 34.

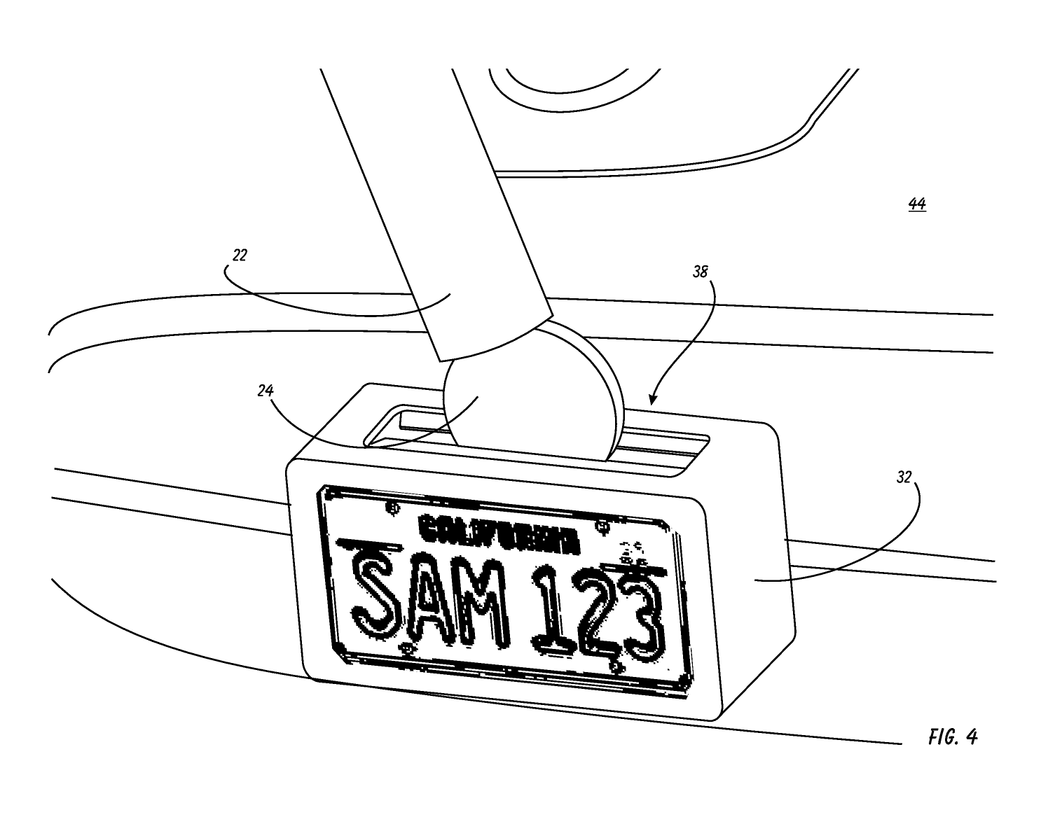

The first and second doors 40A and 40B, respectively, are hinged at their outer edges (i.e. so that they can be pressed down in the middle to create an opening), and meet one another at their respective central edges 42. When the interconnect element (see FIG. 2) pushes down on the doors 40A and 40B, the doors will open (downwardly) and the interconnect element (see FIG. 2) will be free to engage the contact blade located within the housing 34. This operational position is depicted in FIG. 4.

FIG. 4 is a perspective view of the element 24 of FIG. 2 engaging the holder 32 of FIG. 3. As shown, the charging assembly has extended the distal arm segment 22 until the interconnect element 24 has been pushed down until it has engaged the receiver 38 within the modified license plate holder 32. When the vehicle charging is complete, the charging assembly will pull up on the interconnect element 24 in order to disengage it from the receiver 38, and the first and second doors will close in order to protect the internal components of the receiver 38 from environmental damage.

It should be understood that the receiver 38 is electrically connected to the vehicle's normal charging loop such that it is a temporary bypass for the original equipment charging socket located in the vehicle 44. Presumably the OE charging socket will remain operational so that the driver can charge the vehicle 44 at conventional manual cable charging stations.

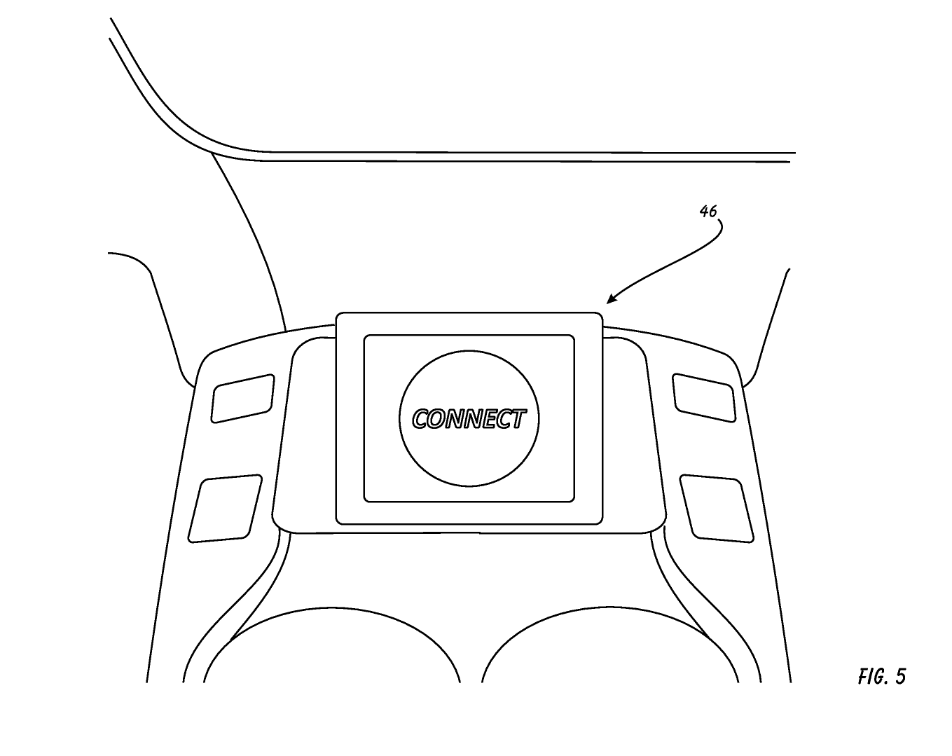

FIG. 5 is a top view of a preferred control interface device 46 for interacting with the assembly of FIG. 1. The device 46 provides the driver with visual and audible feedback through the “docking” and charging process. The driver will be presented with prompts for commencing the interconnect with the vehicle charging assembly, as well as error information for conditions where docking/interconnection is not possible due to vehicle positioning or other errors. In this depicted version, the device 46 is a discrete, separate unit. In other versions, it could be functionality incorporated into the other display/control devices available to the driver in the vehicle (i.e. on the same screen as a GPS or multimedia player on the vehicle dashboard).

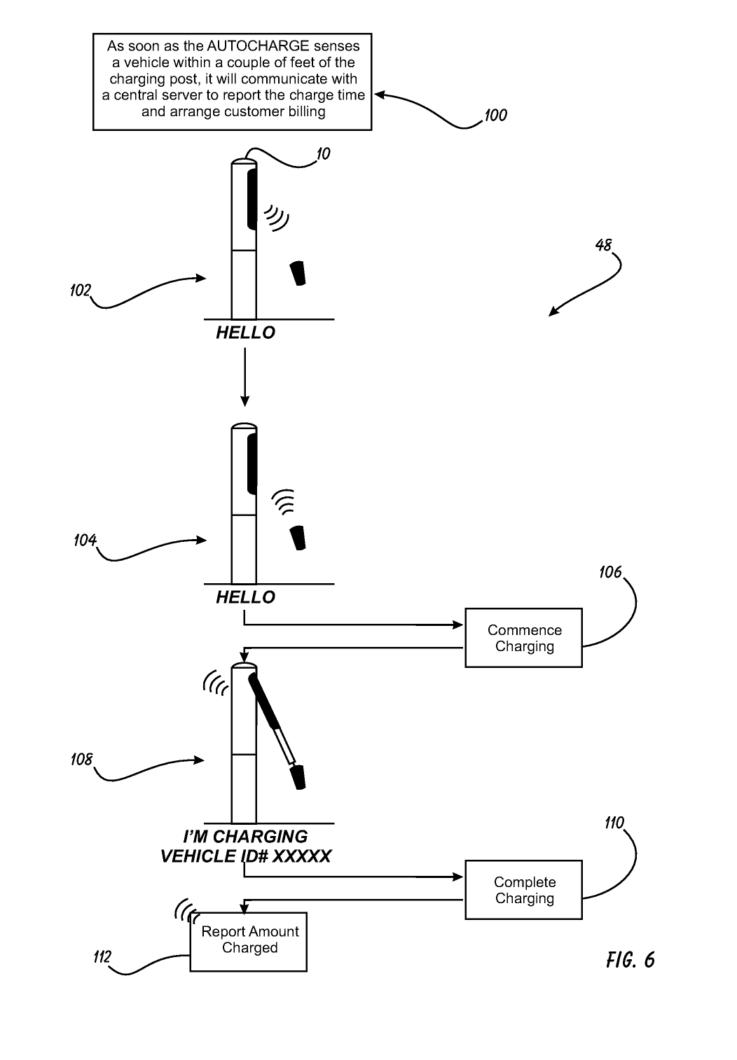

In another non-depicted version of the invention, the control interface device 46 is located within a (typically mobile) computing device, such as a “smartphone.” In such a case, the charge station [10] would need to independently confirm the identification of the vehicle [44]. The initiation and financial portions of the charge transaction are controlled by the control interface software application within the mobile computing device. FIG. 6 depicts the process followed by the system.

FIG. 6 is a flowchart depicting the preferred steps of the charging method 48 of present invention. First, at steps 100 and 102, the vehicle charging assembly 10 detects when a compatible vehicle arrives at a location that is within a few feet of the assembly 10, and will communicate wirelessly with the vehicle-borne subsystem to which the control interface device [46] is connected.

Next, step 104, the vehicle-borne subsystem, upon being queried by the vehicle charging assembly 10, will divulge its identification number. The vehicle charging assembly 10 will communicate with a central server computer by conventional means in order to verify the vehicle identification and that billing records have been established. This account information is established when the charging system of the present invention is installed (or activated) in the vehicle.

Next, 106, the assembly 10 will engage the interconnect element (24—see FIG. 1) into the receiver [38] and charging will commence. This charging status will be communicated from the assembly 10 to the central server computer (step 108).

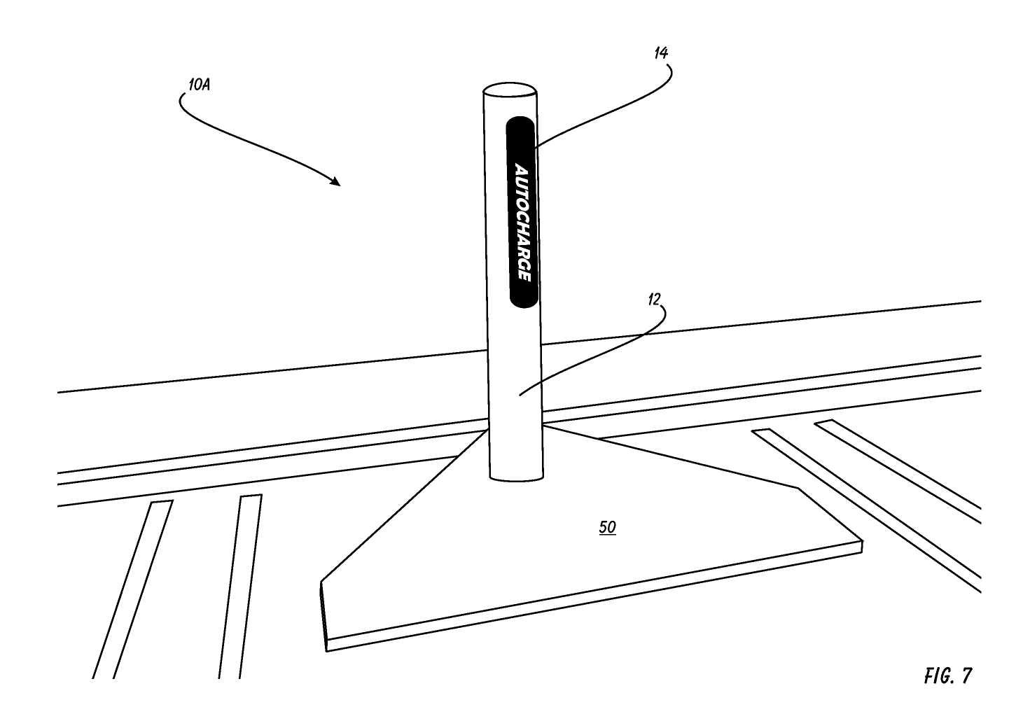

Upon completion of charging 110, the assembly 10 will disconnect (without the need for any actions by the driver unless the driver desires to depart before a complete charge has been obtained), and the assembly 10 will report the amount of electrical charge provided to the vehicle to the central server computer (step 112). The charging method 48 is thereby complete, and the driver has not been required to touch any cables or connectors. FIG. 7 is another embodiment of the present invention.

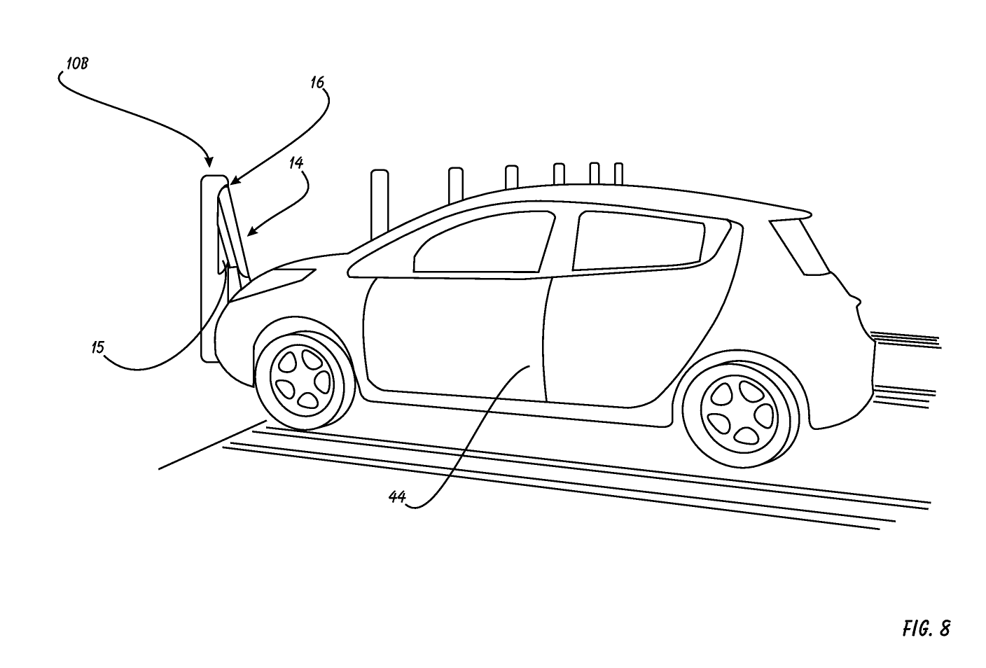

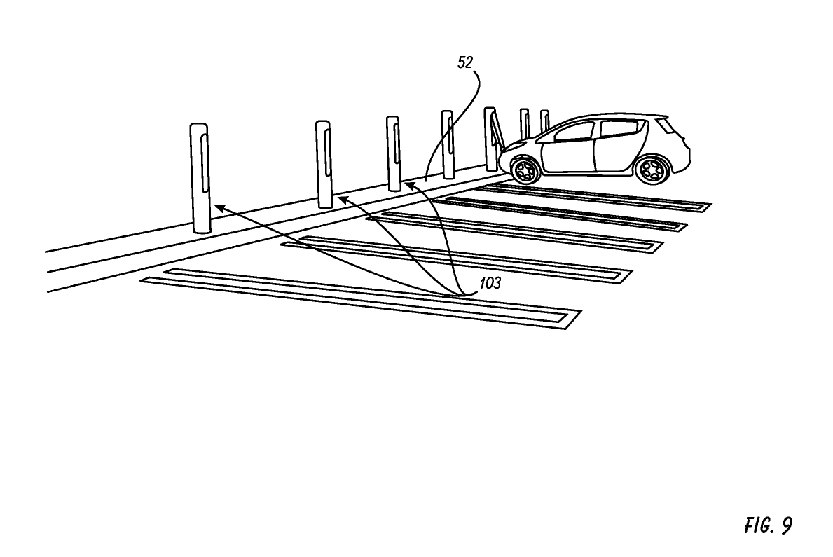

FIG. 7 is a perspective view of a retrofit version 10A of the assembly of FIG. 1. This version 10A is designed for those installations in an existing parking lot, or in circumstances where a somewhat less-permanent installation is desired. Instead of sinking the main post 12 into concrete, the assembly 10A is a modular unit that is set into place in a conventional parking space and then anchored there. There is a base 50 to provide sufficient stability and to aide the drivers in placement of the parked vehicle when charging is desired so the the robotic arm 14 can reach the receiver [38] to commence the charging process. Since communications with the central server computer could be conducted wirelessly, the assembly 10A would only need to be supplied with an electrical power source for vehicle charging. FIGS. 8 and 9 depict the permanently-installed version of the assembly.

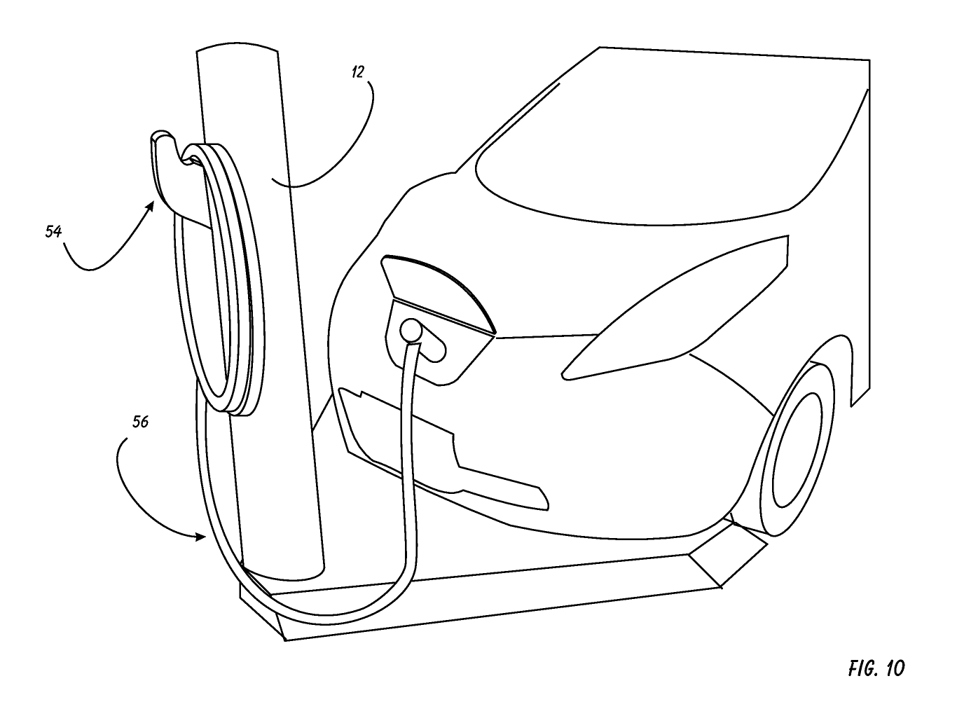

FIG. 8 is a side view of an EV engaged with the permanent version of the assembly 10B of FIGS. 1 and 7 during a charging session. The vehicle 44 is parked in an appropriate location directly in front of the vehicle charging assembly 10B, and the robotic arm 14 has swung out on its hinge 16 so that it is clear of the arm cavity 15 in the rotating post. As shown in FIG. 9, a plurality of vehicle charging assemblies 10B could be installed in a custom-formed parking island 52 in order to create a series of automated EV charging stations. Again, this would typically be the approach used when either a new parking lot is created for the EV's, or where the less permanent installation of the assembly 10A of FIG. 7 is not desirable. We will now turn to FIG. 10 to examine an additional detail of the instant invention.

FIG. 10 is a perspective view of the assembly of FIG. 7, depicting the use of the backup conventional charging cable 56. In some circumstances, a particular vehicle will not have the proper equipment to mate with the automated charging features of the vehicle charging assembly of the present invention. It is for this reason and an optional accessory to the standard automated system would be to add a backup charging cable 56. The cable 56 would preferably hang from a cable rack 54 on the back-side of the post 12, and would function just as a normal manual plug-in EV charging station prior to the introduction of the instant invention. This optional accessory would be available at either version of the charging assembly (10A or 10B).

There are three economically feasible ways in which the arm [14] can find the receiver [38]: Radio Frequency (RF) positioning; Infrared (IR) positioning, and Video Image Processing. Each of these three approaches would enable the charging assembly [10] to “see” or “locate” the receiver [38], and then direct the arm [14] to steer the interconnect element

towards it. Each of these approaches could be employed (individually or in combination or as partial alternatives) by the present invention.

Generically, one or more transmitters in or on the vehicle [44] near the receiver [38], and or more receivers on the arm [14] (usually located close to, or even encircling the interconnect element [24]). The transmitter(s) and receiver(s) could employ RF, IR or other wireless technology to transmit and receive signals. In fact, a single charge station [10] could embody the capability of responding to many different electronic signals (to accomodate a variety of different vehicle configurations). In operation, the vehicle transmitter(s) send a signal that is received by the charge station receiver(s). A suitably-configured computing system analyzes the received signals and directs the arm [14] to move the interconnect element [24] to engage the receiver [38].

It may also be possible for one or more video cameras (in communication with the charge station [10]) to identify and locate the receiver [38] and interconnect element [24], and to then provide video feedback while the arm [14] travels on an intersect course to insert the interconnect [24] element into the receiver [38]. In fact, it may be possible for video cameras located on the vehicle [44] (e.g. those already used by the vehicle driver for other purposes) to play a role in the interconnection process by communicating location information of the interconnect element [24] as it homes in on the receiver [38].

Those skilled in the art will appreciate that various adaptations and modifications of the just-described preferred embodiment can be configured without departing from the scope and spirit of the invention. Therefore, it is to be understood that, within the scope of the appended claims, the invention may be practiced other than as specifically described herein.

What is claimed is:

1. A method for charging batteries within a motor vehicle, comprising the steps of:
discovering that a cooperatively-chargeable vehicle is within range of a charging station;
exchanging vehicle information between said vehicle and said charging station;
locating the position of an interlock element at a distal end of a robotic arm extenable from said charging station;
locating the position of a receiver at said vehicle; and
positioning said interlock element into said receiver by repeating said locating steps as said charging station moves said robotic arm to insert said interlock element into said receiver.

2. The method of claim 1, wherein said locating steps are conducted by operation of a plurality of infrared transceivers in communication with said charging station.

3. The method of claim 1, wherein said locating steps are conducted by operation of a plurality of radio frequency transceivers in communication with said charging station.

4. The method of claim 1, wherein said locating steps are conducted by operation of one or more video cameras transmitting video data to said charging station.

5. The method of claim 1, further comprising an initiation step after said exchanging step, said initiation step activated at a control interface device.

6. The method of claim 5, wherein said control interface device of said initiation step comprises a touch-sensitive surface located in the interior of said vehicle.

7. The method of claim 5, wherein said control interface device of said initiation step comprises a touch-sensitive portion of a mobile computing device.

8. A charging station for charging batteries within a motor vehicle, comprising:
a generally upright post;
an articulating arm extendable from said post, said arm terminating in an interlock element;
positioning means for causing said arm to extend, translate and rotate in order to insert said interlock element into a receiver located at the vehicle; and
locating means associated with said charging station for locating the positions of said receiver and said interlock elemente as said positioning means positions said interlock element in said receiver.

9. The station of claim 8, wherein said post is pivotally mounted to a surface, and said positioning means is located within said post and said articulating arm.

10. The station of claim 9, wherein said interlock element is defined by first and second paddle elements in spaced relative relation, wich said interlock element pivotally attached to said arm.

11. The station of claim 10, wherein said arm attaches to said post at a hinge, said hinge attached to a proximal arm segment, aid arm further defined by a distal arm segment extendable from said proximal arm segment via operation of said positioning means.

12. The station of claim 11, wherein said post is further defined by an arm cavity formed within it for accepting said arm therein.

13. A system for charging batteries within a motor vehicle, comprising:
a charging station having a robotic arm terminating in an interlock element, said charging station having an internal positioning system for moving said arm;
a vehicle having a receiver defined by a receptacle for said interlock element, said receiver disposed on the outer surface of said vehicle;
locating means for determining the locations of said interlock element and said receptacle; and
communication means between said charging station and said vehicle for exchanging vehicle and charging information.

14. The system of claim 13, wherein said charging station comprises:
a generally upright post;
said robotic arm extendable from said post;
positioning means within said post for causing said arm to extend, translate and rotate in order to insert said interlock element into a receiver located at the vehicle; and
locating means associated with said charging station for locating the positions of said receiver and said interlock elemente as said positioning means positions said interlock element in said receiver.

15. The system of claim 14, wherein said post is pivotally mounted to a surface, and said positioning means is located within said post and said robotic arm.

16. The system of claim 15, wherein said interlock element is defined by first and second paddle elements in spaced relative relation, wich said interlock element pivotally attached to said arm.

17. The system of claim 16, wherein said arm attaches to said post at a hinge, said hinge attached to a proximal arm segment, aid arm further defined by a distal arm segment extendable from said proximal arm segment via operation of said positioning means.

18. The system of claim 17, wherein said post is further defined by an arm cavity formed within it for accepting said arm therein.

19. The system of claim 13, wherein said receiver is attached to the outside of said vehicle, and is further defined by a license plate receptacle.

20. The system of claim 19, wherein said receptacle within said receiver is accessed through one or more door panels on a top face of said receiver.
